(19) United States
(12) Patent Application Publication
(10) Pub. No.: US 2008/0205789 A1
(43) Pub. Date: Aug. 28, 2008

(54) Dynamic Photo Collage

(75) Inventors: Warner Rudolph Theophile Ten Kate, Waalre (NL); Johannes Henricus Maria Korst, Eindhoven (NL); Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,021

(22) PCT Filed: Jan. 26, 2006
(86) PCT No.: PCT/IB06/50292

§ 371 Date: Jul. 30, 2007

(30) Foreign Application Priority Data
Jan. 26, 2006 (WO) IB2006/050292

(51) Int. Cl. G06K 9/36

(52) U.S. Cl. 382/284

(57) ABSTRACT

The invention proposes a photo display system that allows photo collages from any photo collection (2), in which the collage is changing over time in such a way that the refresh time and presentation form is dependent on user choices for selection and non-selection on photo per photo basis. The display dynamics of each photo are also dependent on the characteristics of the photo relative to that of the other photos in the collection (2), including such matters as photo quality and uniqueness of picture action.

The invention relates to the field of digital image displays, and more particularly to a system for displaying a dynamic photo collage in which user-defined inputs are used to prioritize and categorize a group or groups of digital photos based on various criteria, for proportionate display on a viewing device.

Picture taking is a widely popular means for people to enjoy an experience, to express and communicate the experience with other people, and to memorize and to re-evoke the experience at a later date. With the advent of digital photography the opportunities for enhancing such enjoyment have been expanded. For example, mobile phones incorporating digital cameras allow compact carriage and also facilitate communication of digital images, nearly instantaneously. Image editors and other software tools enable a user to modify pictures in a variety of ways, such as to add the photographer to the scene, change shadings or colorations, morph faces for fun, etc., as well as to combine pictures, integrating individual shots to form panorama views, and to create collages.

In addition to viewing photographs in the traditional, paper print manner, digital photographs are commonly stored on CD-ROM or other recordable media and viewed using home computers. Other electronic displays of photos are currently known. For example, digital cameras themselves can be used as display devices, for example being passed around the dinner table to show views of photos just or recently taken.

One form of a digital image display is a photo collage. Collages can relate to a certain special event, like a holiday, a wedding, or an anniversary. Thus, from a set of photos taken at the event, the most attractive, memorable, typical or otherwise interesting photos can be chosen and artistically grouped together in a single frame to be placed in a frame or hung on a wall.

Digital creation of collages can be performed using known image editors such as Photoshop®. These solutions, however, are static in the sense that once the collage has been created or edited, it is fixed. Digital displays designed in the form of a photo frame are also known. Such frames are useful in that they can be automatically reloaded, which allows for dynamic display of images. Such a dynamic frame (commonly called a Digital Media Frame, or “DMF”) is described by Kodak in U.S. Pat. No. 6,535,228 to Bandaru, et al., titled “Method and System for Sharing Images Using a Digital Media Frame.”

Known software tools can also be used to provide a dynamic display of digital photos from CD-ROM or a computer's hard drive. A series of digital photos can be selected, and each photo can be shown for a discrete amount of time, cycling through the photos at a steady pace. These display methods, however, do not account for displaying the photos in a manner that represents the viewer's particular relative interest in each individual photo. Even though all photos of a given set or group might be of general interest to a viewer, each photo will almost certainly inspire a different level of individual interest from the viewer. This individual level of interest can be temporal in nature (e.g. more recent photos may be of greater interest than older photos), or it can be based on a particular recent event (e.g. a recent wedding, graduation, etc.). Additionally, since photos often differ in quality (focus or exposure) and composition (everyone present with laughing faces), such characteristics will likewise figure into the viewer's overall desire to see one photo over another. Furthermore, within a given set or group of photos there can often be multiple photos of the same or similar action, and although all might be highly interesting and of prime quality, the viewer still may wish to skip some of them. Conversely, where relatively few images of a specific action or location exist in the group or set, even pictures having poor image quality or other problem may still be preferred for display.

Thus, there is a need for a photo display system that enables the display of a dynamic photo collage from a collection of digital photos, in which the collage appearance can change based on a user-selected prioritization of individual photos.

A method for providing a dynamic photo collage is disclosed, said method comprising the steps of: receiving a group of digital images; assigning ranks to at least first and second images of the group of digital images; and using the ranks assigned to the first and second images to control a display attribute of the images relative to each other when the images are displayed on a display device.

A method for providing a digital photo collage is disclosed, said method comprising the steps of: obtaining a plurality of digital images; obtaining a user-ranking for each image of the plurality of digital images; and displaying at least two images of the group of digital images on a display device; wherein the two images each have a display size, display time, or display position on the display device based on the user-ranking of the image.

A method for displaying a photo collage, comprising the steps of: assigning a rank to a plurality of digital images stored on a storage medium, the user-selected rank being based on a content or quality of each digital image of the plurality of digital images; assigning a display time or display size identifier to each image, said identifier based on the user-selected rank; and displaying at least a portion of the plurality of digital images on a display device; wherein each of the images is displayed for a time period based on the user-selected rank.

These and other features and advantages of the present invention will be more fully disclosed in the following detailed description of the preferred embodiment of the invention, which is to be considered together with the accompanying drawings wherein like numbers refer to like parts, and further wherein:

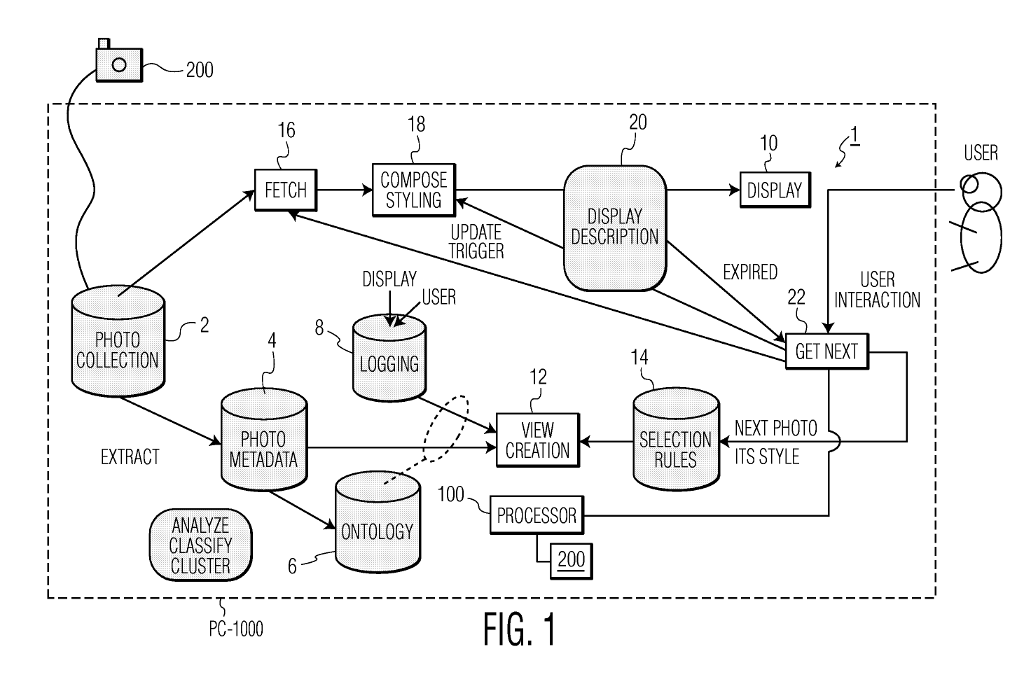

FIG. 1 is a logical view of a system to create a dynamic photo collage according to the invention;

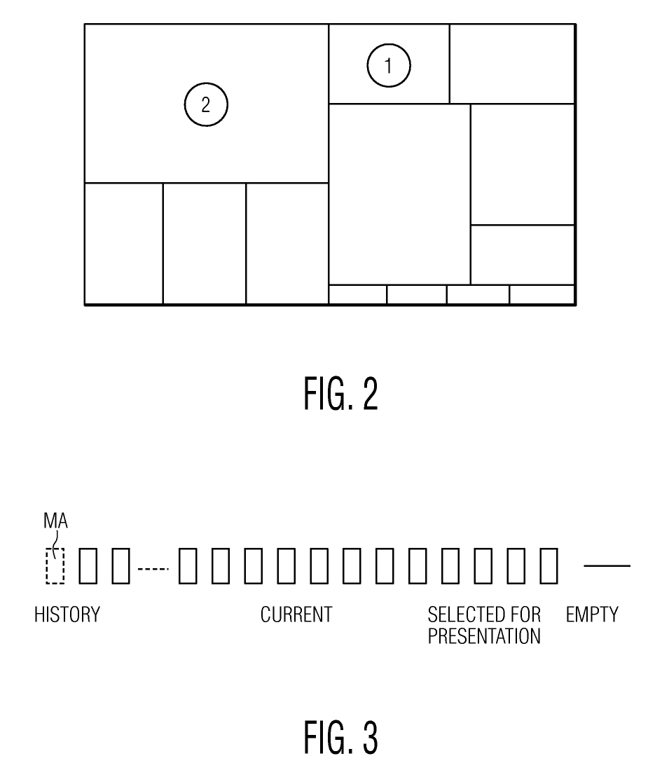

FIG. 2 is an example layout showing a tiling stile of the dynamic photo collage of FIG. 1;

FIG. 3 is a history track and display plan of the system to create dynamic photo collage of FIG. 1;

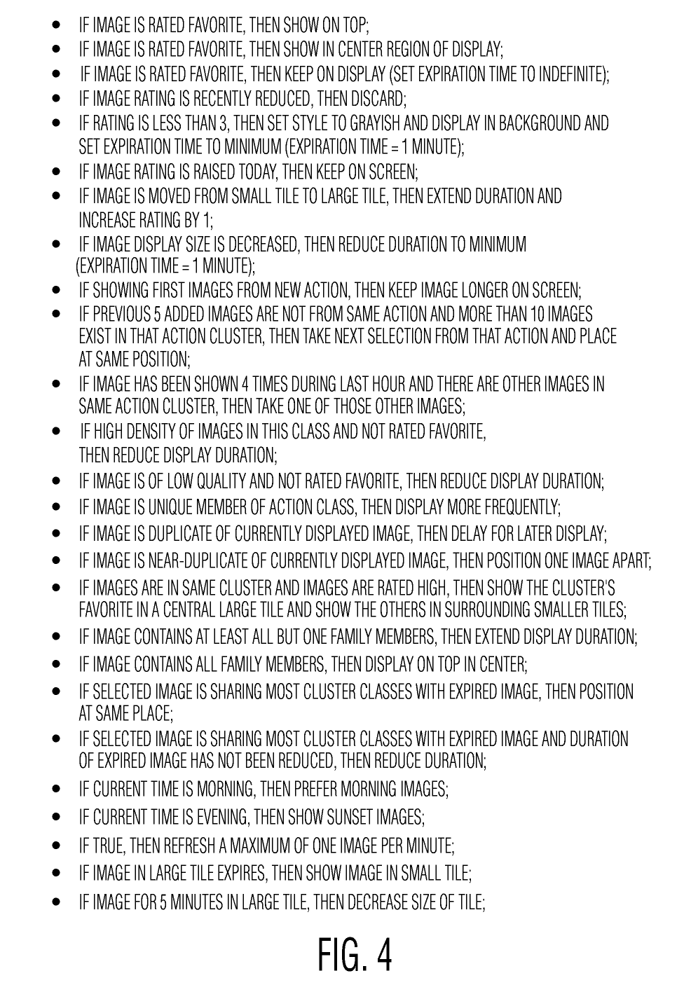

FIG. 4 is a sample listing of selection rules for use with the system of FIG. 1.

A digital image collage system is disclosed in which the refresh time and presentation form of each image in a collection of images is controllable and can depend on user-input preferences for each photo. Thus, for a highly preferred image, the duration and frequency of appearance of the image can be greater than that of a less preferred image. Likewise, the layout and styling of the highly preferred image may be different than that of less preferred images. The display dynamics of each image also can be dependent on the inherent characteristics of the image relative to that of the other images in the collection, based on relative image quality and the uniqueness of any pictured actions. For example, attractive, high-quality images can be displayed for longer periods of time, or can be permanently displayed on a portion of the display device, as compared to image of lesser quality or less desirable content. The display dynamics of the system can be controllable by the user.

It is noted that although the invention is generally described in relation to its applicability to a collection of digital photos, that it is broadly applicable to the display of digital “images.” Where digital photos are used, the photo can be captured by a digital camera. The image may have any known format, such as JPEG, TIFF, GIF, BMP, PCX, et al. The image may alternatively be a video sequence, such as MPEG or any variation thereof.

Referring to FIG. 1, a system 1 is illustrated for controlling the display of a group of digital photos on a display device, in which the individual photos of the group can be displayed for different lengths of time, and can also occupy different relative percentages of the display screen, depending upon various user-input preferences as well as various inherent characteristics of each photo.

A camera 200 can communicate with a processor 100 which may be associated with a personal computer 1000 or other electronic device. The processor 100 can be controlled by a user or viewer via a user interface associated with the electronic device. The processor 100 can operate to instruct the camera to transmit one or more photos or video sequences to a data storage device associated with the processor. In the FIG. 1 embodiment, the camera can be instructed by the processor to transmit the photos or video sequences to a digital image collection 2 via a hard wire connection (e.g. USB, parallel or serial port) or a wireless connection. Although the system is described for use with a personal computer PC-1000, other appropriate electronic devices can be used, and so, for example, the processor 100 can be part of the display device 10, or could even be part of the camera. The processor 100 can have one or more memory components 200 associated therewith, for storing operating instructions for the processor. In one embodiment, the memory 200 can be RAM, although any other appropriate memory type can also be used. As will be appreciated when considering FIG. 1, the rectangular elements represent tasks and/or processes that will logically “run” on the processor of the user's computer. The cylindrical elements represent data stores that will logically reside on the user's computer, for example on its hard disc. It will be appreciated that the tasks/processes and the data could also reside on a remote computer, server, etc. and could be accessible to the user computer which can have the appropriate connectivity hardware and software. The Analyze/Classify/Cluster block (shown in FIG. 1 as associated with the metadata database 4 and the ontology 6 is also a process task, but it typically will “run” off-line (i.e. before or asynchronous with the other processes (rectangular elements)). The “Display Description” 20 is a logical document, which will typically be stored in RAM of the user's computer.

The processor 100 can operate to direct the display of the collection of digital images 2 to a viewer using a digital display device 10, such as a computer screen, the video screen of a cellular telephone, a personal digital assistant, or a specialized digital photo frame. The collection 2 can be either a closed set of images, such as a saved set or group of images on the user's computer hard drive (HD) which have been downloaded at a previous point in time. Alternatively, the collection could be open-ended, such as a set or group of images that are accessible from a remote computer or server via a link or links to the Internet. The collection 2 can be stored on the user's computer hard drive, random access memory (RAM), flash memory, removable media, or other storage media. Alternatively, the collection can be stored in a combination of such media, or on another computer to which access is gained via a network.

The images in the collection 2 can be associated with a separate database of information relating to the images. In one embodiment, a metadata database 4 is provided and maintains information regarding at least a portion of the images in the collection 2. An ontology 6 may be provided that relates relatively low-level features in the metadata database 4 to more user-oriented or higher-level concepts. For example, the ontology 6 may describe classes that form the clusters which relate various of the images of the collection together based on the similarity in their metadata characteristics. A logging database 8 can also be provided to maintain a history of the display events relating to the photo collection. A view creation module 12 can be provided which responds to user commands regarding the display of digital images and which uses information gained from the metadata database 4, the ontology 6 and the logging database 8 to assemble a photo collage.

The view creation module 12 can be controlled by a set of selection rules 14, which are selectable or manipulable by the user to change the characteristics of the display, for example, giving priority to images from a certain event, or from a certain time period.

Based on the selection rules 14, the control program can instruct a fetch routine 16 to fetch the photos in the collection 2 that meet the desired criteria, so that the fetched photos can be displayed, in relative sequence, on the display device 10. Selection can be based on the metadata 4 associated with each photo, and can also be based on information provided by the ontology 6 or the logging database 8.

A styling module 18 can be used to select a desired display hierarchy for the fetched images. For example, multiple images may be selected for display simultaneously, with the most highly preferred image placed in the center of the display and less preferred images arranged around the outer periphery of the display. A display loop 20 can be used to change the displayed images at a selected periodic rate.

It will be appreciated that the illustration of FIG. 1 is merely representative in nature, and thus it shows one possible scheme for the interconnection of the individual modules. In addition, what is represented as a single module in the figure may be practically contained in a number of different modules. Thus, for example, the metadata database 4 need not be a physically identifiable discrete entity, but may rather be simply a representation of meta data that is contained in multiple different logical and physical locations.

Referring again to FIG. 1, the metadata database 4 can contain various amounts of metadata for each image. The metadata describe the photos in terms of their characteristics such as the date and time in which the image was created, as well as the location where the image was created. Semantically more meaningful data are held in the ontology 6. For example, while the metadata database 4 can be used to store attributive information about the images (e.g.,. GPS coordinates for the location in which a digital photo image was taken), the ontology 6 can provide relationships between the GPS coordinates and the places on earth, such as city names, mountain summits, island shores etc.

The metadata database 4 can also have a rating table that ranks the stored images for display preferences. The rating table can be created by a user of the digital photo collage, or it can be derived from a default scheme (i.e., an algorithm). For example, pictures can be assigned credits based on quality, richness of color, number of recognizable faces, and the like. Multiple different ratings for each image can be provided to allow different users to separately prioritize the images in the collection according to their own personal tastes.

The metadata in database 4 can be generated by the camera used to “take” the digital image. For example, for cameras having date-time and GPS coordinate capabilities, metadata regarding these characteristics can be associated with the images when the image is created (i.e. when the digital picture is “taken”). Metadata can also be added to individual images using feature extraction mechanisms that analyze the raw image encoding. For example, a face recognition algorithm can be used to extract the names of persons in the photo and to associated metadata relating to that person with the image containing the person's likeness. In this case an ontology 6 (described in more detail below) can be used to relate images of family members (e.g. parent, child, uncle). Metadata can also be manually added (i.e. annotated) to the database 4 by one or more users. This manual addition can occur during the process of picture taking (e.g. adding a time/date/place/event), or it can be input later, such as during or after transferring the images to the collection database 2. A wide variety of metadata information can be stored for each image, as will be appreciated by one of ordinary skill in the art. Thus, for example, technical data such as camera type, lens type, focal distance, etc. can be stored. Further, time stamps can be used as metadata, and events such as Christmas, holidays can be stored or otherwise provided to and processed by the ontology, which can then link certain photos by their characteristically particular dates. As additional examples, the ontology 6 can use the metadata to link “family pictures,” or “professional/hobby” (in the case of the camera or lens type) groupings or the like.

As noted, an ontology 6 can be provided to assist the user in automatically grouping and inter-associating photos into different subgroups or subsets. For example, the ontology 6 may be provided with a set of relationships between family members, holidays, locations at which photos were taken, and the like. Internal labels can be defined, and the user can be prompted to manually annotate each photo to associate the photo with a label or labels, as appropriate. Sub-labels can be defined in a similar fashion, for example, “Christmas Eve,” could be a sub-label of “Winter Holiday.” The result is that the ontology 6 can be programmed with a wide variety of different label and sub-label categories, and can thus be used to associate photos with each other based on a wide variety of user-input and previously-defined information.

Thus, in one example, after defining the label “kids,” and annotating an image with that label, the ontology 6 might then prompt the user to identify “which kids?,” whereupon the ontology can provide a list of suggested names (which were previously loaded by the user) or it may allow the user to input new names or lists of names in response to the prompt. Such prompts can be provided for any of the variety of attributes that may be associated with each photo. Additionally, the system can allow the user to limit the number and types of prompts as desired to reduce the total amount of user input required during the rating and classification process.

The ontology 6 may be capable of learning from information that the user provides initially or over time. For example, when the user associates the label “holiday” with a particular image, the ontology can create an internal relationship between the particular label and the date-time codes that are associated with the image by the digital camera. Thus, the ontology 6 may automatically associate the label “Christmas” or “Hanukkah” with images generated during a user-defined portion of the month of December. As will be appreciated, other learnable associations between labels and basic metadata attributed internally or externally to each image are also possible.

In addition to user-provided and algorithmically-generated associations between images, the inherent nature of the images can also be analyzed to provide additional rankings or groupings. For example, appropriate technology can be used to analyze image quality and to assign a relative value for future use in selecting images for presentation. The images can be analyzed for such features of quality as focus (using edge detection methods), light, dark, underexposure, overexposure, etc. This analysis can be performed automatically without user intervention. Alternatively, the user may be allowed to manually enter information regarding photo quality to override the automatic ranking (where used) so that images having a preferred quality (for example, artistically rendered images that are intentionally out of focus, etc.) can still be provided with a relatively high rank. This information can be stored or otherwise applied in the ontology 6.

Furthermore, data-mining techniques can be applied to the images (again, with minimal additional user action) to “cluster” images into classes that are defined in the ontology 6. For example, images having similar or identical date-time metadata or images having the same or similar groups of people (e.g. as rendered by a known face recognition technologies) can be clustered. This can be useful to simplify the classification and grouping process so as to limit the total amount of input required by the user. For example, once the user has manually annotated one or more photos with the label “holiday,” all other images taken in the same time frame can be similarly classified. Likewise, once the user has manually annotated one or more photos as corresponding to a particular geographic location or travel event (e.g. “Mount Etna”), then all other images having similar GPS coordinates can be classified together without additional user action. Thus, the ontology 6 can be used to inter-relate photos by assessing the metadata associated with those photos, and without disturbing or changing the metadata. As such, a nearly infinite variety of associations can be created, recreated, added or changed without affecting the basic data with which the associations are built.

A logging database 8 can also be provided to amass an historical record of what photos have been displayed by the display device. At a basic level, this database 8 can store information about which photos have been displayed together with the dates and times of such display or displays. Relative display times and display sizes for each image can also be stored. The logging database 8 also can store a variety of other information about the display history of the device, such as what individual groups of photos have been displayed (optionally also associated with time and date), and particular historical viewings for each individual viewer or user. The logging database 8 can also store information about user interactions with the display, and the time such interaction took place. For example, the user may rate a photo favorite, assign a dislike for a particular photo or group of photos, or may perform some other modification to the display settings.

It will be appreciated by one of ordinary skill in the art that the information collected in the logging database 8 could itself be used for developing new groups or collections of photos, such as a group of images labeled “favorites,” “recently displayed,” or the like. This information can also be provided to the ontology 6 to develop such new groups, collections, or to develop new image “relationships.”

The processor 100 can control a variety of individual process modules that can be used to create a desired display of digital images. A set of image selection rules is contained in the selection rules database 14. These rules are used to control the dynamics of the collage display. In one embodiment, the rules are in “if then” formulation, although other representations can be used as appropriate. Generally, the selection rules can appear as a set of constraints or as evaluations of the individual images. The selection rules can be provided in various sets or groups corresponding to different contexts or events. An example of a “context” would be a particular user. Thus, each user can have his or her own “context” within the selection rules, which enables the personalized selection of photos for display (as well as their display characteristics) based on the preferences of the individual user. Each user then can have his or her own customized set of selection rules within the database 14. When a user “logs in” to the system, or provides to the processor some other indication of personalization, the processor can pull the selection rules relating to that user from the database 14 in order to display photos based on that user's preferences. The contexts can also be part of the rules themselves, which would allow the user to mix contexts in the rules definitions. Examples of context oriented selection rules are as follows:
IF [current content==]Party THEN display colorful images; or
IF [current_user==]Jonathan THEN include rules for Margareth

A listing of exemplary selection rules that can reside in the selection rules database 14 is shown in FIG. 4.

The system 1 can employ a “Get Next” process module 22 to read the selection rules 14 to “select” a next photo from the photo collection 2 for display. The “Get Next” module also uses the selection rules to determine the presentation or display style (i.e. its size, orientation, etc.) of the next photo. This identity of the next photo (i.e. its photo ID), as well as the display style, are sent to the “fetch” process module 16, which “reads” the photo from the photo collection database 2 and sends it to a list or queue in the Display Description module 20 where it can be used to replace an expired (i.e. previous) photo. The new (next) photo is then sent to the display 10 for presentation to the viewer. While logically, the display loads a complete new description, practically only the changed portions need actually be rendered. The component images of the display are “shown” and then “expire,” to be replaced by other images. This replacement can induce a recomposition of the displayed image or images, depending on the rules applied. As will be appreciated, replacement does not necessarily occur according to a strict or fixed sequence nor is it completely random. Rather, it is based on relations between the metadata of the photos in the collection 2, and in particular between the “replacing” and “replaced” photos. These relations can include classes/clusters of equivalent/similar photos as previously discussed. The modules in FIG. 1 illustrate and represent the main tasks performed to implement this process

The view creation module 12 operates as an intermediate processing module which uses the ontology 6 to provide views on the metadata and logging data that are suitable for use by the get-next module in implementing the selection rules 14. The ontology 6 and view creation module 12 enable the rules to be expressed in terms of the desired display dynamics. For example, two selection rules could be:
IF expired image is from holiday THEN take next from holiday in Paris
IF expired image is from holiday in Paris THEN take next from holiday not in Paris

The rules use a high-level description, and when the view creation module 12 processes the rules, it must evaluate whether the premises are TRUE. The database 4 provides low-level metadata (e.g. GPS and timestamp values). The ontology 6 provides the required information to decide whether the given low-level values satisfy the high-level descriptions in the premises (for example, whether the given GPS and timestamp values are in the set “holiday” or “holiday in Paris”). In the above case, the two rules would be conflicting for the case in which both premises evaluate to TRUE. In one embodiment, the ontology 6 could help to resolve such a conflict by identifying that “holiday in Paris” is a subclass of “holiday”, and therefore a more specific concept. The conflict resolution could appropriately prioritize the more specific rule.

When the display 10 is activated, initially one or more of the most desired or favorite photos in the collection 2 is shown. Multiple photos can be shown in a serial fashion, generally in descending order of desirability. Alternatively, more than one photo at a time can be shown, with each photo occupying less than a full percentage of the total screen space. Photos likewise can be overlapped, with more favored photos displayed on the top and less favored photos on the bottom. This arrangement, or “composition,” can be defined in a logical document (for example, the Display Description module 20) which describes the photos, their layout, the duration of their respective display, and their styling. The Display Description 20 could initially be stored on the user's computer, however, the running version would be stored in RAM and would be continuously modified as images expire and are replaced. The description is logical, so for example, the styling module 18 could hold a table of images and their position on the screen, and could directly update the display 10 with a next composition. In this setting there is no “document” in between, into which 18 writes and 10 reads. In addition to the composition, the styling of each photograph can be controlled, including, for example, the richness/grayness of the colors, brightness, etc. Typically, the composition will ensure that a favorite photo or photos will be displayed in the foreground, will occupy a relatively larger portion of the screen, and will stay on the screen for a longer period of time, as compared to less favored photos.

As noted, a wide variety of compositional styles can be implemented. For example, the photos may be partially overlapped, with the more favored photos on top and the less favored photos underneath. A tiling layout can also be provided for in the manner illustrated in FIG. 2. In the FIG. 2 embodiment, multiple photos 1, 2 can be displayed at one time, with each photo having a specific size and orientation (i.e. landscape, portrait, etc.). Again, the more favored photos can occupy a relatively larger portion of the screen than less favored photos. Combinations of different compositional types are possible, such as a combination of overlapping and tiling layouts, as are other layouts as will be appreciated by one of skill in the art.

The values which affect composition style and duration can be stored in a separate table in the metadata database 4, and are derived in a manner similar to that used to obtain the ratings for each photo or group of photos. The user may alter the stored values, or may implement a separate custom set of values that apply to that user alone. (It is noted that in addition to changing the characteristic values, that the user could also change the rules to effect a similar result.)

The selection rules 14 control the dynamics of the collage, and the “Get Next” process module 22 employs the rules 14 to select a next photo and its manner of display (i.e. the style in which the photo will be displayed). The identification information relating to the next photo is sent to the fetch process module 16, and the photo is then (logically) added to the Display Description 20. When the display duration of a given photo in the document expires, the Get Next process module 22 issues a call to the Display Description module 20 for the next photo to be displayed. The Display Description module 20 is a logical document that indicates what images will be displayed in what location on the display. The Styling Module 18 writes into the document 20 and the display module 10 reads from it. Thus, it can be thought of as performing an interface role between the Styling and Display modules 18, 10. The modified description (i.e. the new photo) is then sent to the display 10. Logically, the display 10 will load a complete new image description (i.e. a new photo) for display. In an alternative embodiment, only the change in the display can be rendered. Thus, for photo collages in which multiple photos are shown simultaneously, only the changed photo information need be rendered.

It is noted that the user can manually enter a “Get Next” call for a next photo by interacting with the display device. The user can also override or suppress a “Get Next” call for an expiring photo in order to maintain a photo on the display for a period longer than would occur under the rules. In addition to manually changing the duration of display for a selected photo, the user can also move a photo around within the display, such as changing its position as a small tile to a large tile (e.g., from number “1” to number “2” in FIG. 2).

As previously noted, examples of various selection rules are contained in FIG. 4. Although the examples suggest a formulation comprising a standard IF, THEN form, other representations can also be used. For example, the rules can appear as a set of constraints or as evaluation functions on the photos and their possible display description, etc. For example, taking the first rule from FIG. 4:
IF image is rated favorite THEN show on top
constraint: ∀i,j: (rate(photo[i])-rate(photo[j])(top(photo[i])-top(photo[j]))>0
function: top(photo[i])=rate(photo[i])/max_rate

Furthermore, combinations of different type of rules are also contemplated and can be used.

In an alternative embodiment, a user can develop and store one or more preselected play lists. Such play lists can be stored on the hard disc of the user's computer as a sequence of Display Description documents, or, when assembled together into a single document, the could be a Dynamic Display Description document. The benefit of providing such preselected lists is that they can be based solely on a manual user selection of discrete photos, and would not be based in any metadata or ontological ratings criteria. Various different preselected play lists can be pre-constructed and stored so that a single user can have at his or her disposal more than one play list. Likewise, multiple users each could have their own play list.

An illustration of a further alternative embodiment is provided in FIG. 3, in which the system maintains a log of the frequency statistics and presentation duration (e.g. start and ending times of display intervals) of each of the displayed photos, and then re-displays them according to that history. This history can be maintained in the logging database 8, and can be summarized using statistical modeling techniques. One such statistical modeling technique is described in currently-pending PCT application WO 02/095611, titled “Selection of an Item,” by Vincentius Buil, the entirety of which is incorporated herein by reference, in which the popularity and recency (or “freshness”) of multimedia content are operationalized. This technique is extended by introducing an additional element termed “satiation.” “Popular” photos are those that are displayed more frequently than others. “Recent” photos are those that are displayed more recently than others. “Satiated” photos are those that are displayed longer than others. To this end, let M denote the number of photos in the collection.

A measure for the popularity of photo i, can be identified as Pᵢ, where

$${P}_{i} = \frac{{n}_{i}}{{\sum }_{i = 1}^{M} {n}_{i}}$$

and where nᵢ denotes the number of times that photo i has been displayed. It is simply the proportion (expressed from 0 to 1) of the times that photo i has been displayed relative to the total number of times all photos have been displayed. Special attention has to be paid to extreme condition (e.g., nᵢ=0)

A measure for the recency of photo i, can be identified as Rᵢ, where:

$${R}_{i} = ( {t}_{now} - {e}_{{in}_{i}} ) \frac{{n}_{i}}{{\sum }_{j = 1}^{{n}_{i}} ( {e}_{i ( j + 1 )} - {e}_{ij} )} ,$$

where t_{now} denotes current system time, and where eᵢⱼ denotes the end time of the j-th display interval of photo i. It is simply the ratio between the time period that elapsed since the latest display of photo i and the mean of the time periods between all other display intervals. To make it a proportional number, Rᵢ is divided by a maximum value that is computed.

A measure for satiation of photo i, Sᵢ, is

$${S}_{i} = 1 - \frac{{\sum }_{j = 1}^{{n}_{i}} ( {e}_{ij} - {b}_{ij} )}{{\sum }_{i = 1}^{M} {\sum }_{j = 1}^{{n}_{i}} ( {e}_{ij} - {b}_{ij} )} ,$$

where bᵢⱼ denotes the starting time of the j-th display interval of photo i. Si is simply the converse proportion of the total display duration of photo i relative to the total display duration of all photos combined.

A convex combination of the logarithm of the three measures results into:
Uᵢ=wₚ log(Pᵢ)+wᵣ log(Rᵢ)+wₛ log(Sᵢ), where wₚ+wᵣ+wₛ=1 are weights and kept to be equal (i.e. all weights are between 0 and 1 and add up to 1), for simplicity. By a linear transformation, Uᵢ can be converted into chance values that add up to 1,

$${C}_{i} = \frac{1}{{U}_{i} {\sum }_{i = 1}^{M} \frac{1}{{U}_{i}}} .$$

These chance values Cᵢ can then be used by randomly sampling the next photo to be displayed in such a way that the photo that has been displayed least frequently, least recent, and least satiated is most likely to be displayed next.

In this embodiment, display “slots” are generated and stored on the hard disc of the user's computer. These “slots” are part of a mathematical representation, and thus they can be of different duration. Alternatively, they may be of uniform duration and a single photo can fill several consecutive slots. The system processor then computes the photos to fill the next “slots.” based on the analysis just described. Instead of the previously described rule-based display system, a local search can be performed on the attribute-value pairs of the photos that fit within given display frequency and display duration constraints. The matching photos are then identified as candidate slot fillers. Photos have attribute-value pairs (of metadata) such as event, location, person, and picture quality, possibly supported by an ontology for inference purposes. Instead of rules, the wishes of when and what photos will be displayed are coded as constraints which are predicates defined for the slots that must be satisfied. For instance, cardinality constraints can be used to stipulate how many times photos of a particular nature (i.e., having a particular attribute-value pair) are allowed to or need to be assigned to a slot. One constraint could stipulate that “Christmas” photos need to be assigned to 50-70% of the slots. It will be appreciated that other constraints can also be used to define the assignment of photos in successive slots. A sequence of binary constraints can stipulate that pairs of successive slots be assigned photos with particular attribute-value pairs. For instance, that the display of photos dealing with ‘holidays’ should follow each other. Likewise, one can declare what photos should NOT be assigned to slots, or the level of difference of photos across slots. It will be appreciated that it can be hard to satisfy all these constraints simultaneously due to conflicts between individual constraints. One solution is to translate the constraints into piecewise linear penalty functions that express the extent to which a constraint is violated in a proportional manner. For instance, one exemplary penalty function for a cardinality constraint dealing with N slots can be expressed as:

$$f ( x , a , b , N ) = \{ \begin{matrix}0 & a \leq x \leq b \\ \frac{a - x}{max \{ a , N - b \}} & x < a \\ \frac{x - b}{max [ a , N - b \}} & x > b\end{matrix} ,$$

where x is the number of slots with photos that have the desired attribute-value pairs (e.g., “Christmas” photo), where a is the minimum cardinality required, and b is the maximum cardinality allowed. In the example of the “Christmas” photos using 100 slots, a and b should be 50 and 70, respectively. A combination of all penalty functions involved results in an overall penalty function that has to be minimized to solve the problem of assigning photos to slots optimally, but approximately. The use of penalty functions also allows for optimization of the user ratings or image quality of photos that will be assigned to photos. Optimization is realized by performing a local search in which complete slot-photo assignments are evaluated, stepping from assignment to assignment by applying random, small changes to the assignment order. These changes can be performed by randomly drawing photos from (a part of) the photo collection and by exchanging them with others in the assignment, either using a uniform distribution or a distribution that accounts for ‘popularity’, ‘recency’, and ‘satiation’. Incorporation of the latter distribution requires the use of the logging database 6 and the estimation of the required statistics. If the newly created assignment is better than the previous one, the new one is accepted and the next iteration of local search is entered until the assignment is found optimal. A special class of local search algorithms that aims at preventing local optima is known as simulated annealing. The procedure can be performed off-line in which photos are assigned to a pre-defined number of slots, beforehand. Likewise, the procedure can be realized on-line and incrementally, in which an assignment of photos to a small set of slots can be computed ahead (i.e., a window holding the next photos), taken into account the assignment of photos to previous slots (i.e., the display history) and currently prevailing user preferences expressed in the constraints. The display history can either be represented by the actual previous assignments, or be summarized by the logging database 6.

Conceptually, at the application level, the rule resolution and constraint satisfaction systems can be the same as the previously described embodiments. At the implementation level, however, different algorithmic approaches are used, as noted.

It is once again noted that FIG. 1 is intended to provide an illustration of the general flow of information through the system 1. Thus, although FIG. 1 may not show all of the possible permutations of interactions between the various system elements, that any appropriate interaction between elements is nonetheless intended. Furthermore, the elements illustrated need not be discrete entities, but can rather be distributed within the remaining elements. Thus, the described elements should be considered as being representative in nature. For example, instead of providing a separate metadata database 4, the metadata for each image could be stored along with the image itself as part of the photo collection 2, or could be distributed within the ontology 6 or logging database 8.

It is noted that although the invention has generally been described in relation to its use for organizing and displaying digital photographs, that the principle of the invention can be applied to the organization and display of any digital images, whether photographed, scanned, or otherwise created in, or transferred to, a digital medium. Thus, the invention could be used to analyze and display a collection of original artwork that has been scanned and stored on the hard drive of a user computer.

Thus, while the foregoing invention has been described with reference to the above embodiments, various modifications and changes can be made without departing from the spirit of the invention. Accordingly, all such modifications and changes are considered to be within the scope and range of equivalents of the appended claims.

1. A method for providing a dynamic photo collage, said method comprising the steps of:
receiving a group of digital images (2);
assigning ranks to at least first and second images of the group of digital images; and
using the ranks assigned to the first and second images to control a display attribute of the images relative to each other when the images are displayed on a display device (10).

2. The method of claim 1, wherein the step of receiving a group of digital images comprises storing the images in digital form on at least one storage medium (2).

3. The method of claim 1, wherein the step of assigning ranks comprises assigning at least one rank to each image based on image quality, image content or image creation date.

4. The method of claim 1, wherein the display attribute is one of the group consisting of image size on the display device (10), image position on the display device, and time period of display on the display device.

5. The method of claim 1, wherein when the first and second images are displayed on the display device (10), the first image has an image size larger than an image size of the second image based on the relative rankings of the first and second images.

6. The method of claim 1, wherein the display device (1) is a digital picture frame, a cellular telephone, a personal computer, or a personal digital assistant.

7. The method of claim 1, further comprising the step of associating metadata (4) with each image.

8. The method of claim 7, wherein the metadata (4) represents a time at which the image was taken.

9. The method of claim 7, wherein the metadata (4) represents the GPS coordinates for the location at which the image was taken.

10. The method of claim 7, further comprising using an ontology (6) to assign a grouping identifier to at least a portion of the plurality of digital images based on a user input or at least a portion of the metadata (4) associated with each image.

11. A system for displaying a digital photo collage, said system comprising:
a program running on a processor (100);
a database (2) comprising a plurality of digital images;
metadata (4) associated with each of the plurality of digital images; and
a display device (10) in communication with the processor (100) for displaying the plurality of digital images to a viewer;
wherein the processor (100) instructs the display device (10) to display at least two of the plurality of digital images, each of the images having a display size, display time, or display position on the display device (10) that is based on the metadata associated with each image.

12. The system of claim 11, wherein the plurality of digital images are stored in digital form on at least one storage medium (2).

13. The system of claim 11, wherein the metadata comprises information regarding quality, content or creation date of the associated image.

14. The system of claim 11, wherein the processor (100) instructs the display device (10) to display at least two images at the same time.

15. The system of claim 14, wherein one image has an display size larger than a display size of the other image based on a comparison of the their associated metadata.

16. The system of claim 11, wherein the display device (10) is a digital picture frame, a cellular telephone, a personal computer, or a personal digital assistant.

17. The system of claim 16, wherein the metadata represents a time at which the image was taken.

18. The system of claim 16, wherein the metadata represents the GPS coordinates for the location at which the image was taken.

19. The system of claim 16, further comprising an ontology (6) associated with the processor, the ontology (6) being configured to assign a grouping identifier to at least a portion of the plurality of digital images based on a user input or the metadata associated with each image.

20. A dynamic photo collage for displaying a plurality of digital photos, comprising:
a processor (100);
an image database (2) connected to the processor (100), the database comprising a plurality of digital images;
a metadata database (4) connected to the processor, the metadata database comprising information relating to each of the plurality of digital images; and
a display device (10) connected to the processor (100), the database configured for displaying the plurality of digital images to a viewer;
wherein the processor (100) is configured to instruct the display device (10) to display each of the plurality of images for a predetermined time, the predetermined time being based on at least a portion of the metadata associated with each of the plurality of images.

21. The dynamic photo collage of claim 20, wherein the plurality of digital images are stored in digital form on at least one storage medium (2).

22. The dynamic photo collage of claim 20, wherein the metadata comprises information regarding quality, content or creation date of the associated image.

23. The dynamic photo collage of claim 20, wherein the processor (100) instructs the display (10) to display at least two images at he same time

24. The dynamic photo collage of claim 23, wherein one image has an display size larger than a display size of the other image based on a comparison of the their associated metadata.

25. The dynamic photo collage of claim 20, wherein the display device (10) is a digital picture frame, a cellular telephone, a personal computer, or a personal digital assistant.

26. The dynamic photo collage of claim 25, wherein the metadata represents a time at which the photo was taken.

27. The dynamic photo collage of claim 26, wherein the metadata represents the GPS coordinates for the location at which the photo was taken.

28. The dynamic photo collage of claim 20, further comprising an ontology (6) associated with the processor (100), the ontology (6) being configured to assign a grouping identifier to at least a portion of the plurality of digital images based on a user input or the metadata associated with each image.

29. A memory medium (200) for providing a dynamic photo collage, said memory medium comprising:
code for receiving a group of digital images;
code for assigning ranks to at least first and second images of the group of digital images; and
code for using the ranks assigned to the first and second images to control a display attribute of the images relative to each other when the images are displayed on a display device.

30. A device for displaying a digital photo collage, said device comprising:
a processor (100) running a program;
a database (2) comprising a plurality of digital images;
metadata (4) associated with each of the plurality of digital images; and
a display device (10) in communication with the processor (100) for displaying the plurality of digital images to a viewer;
wherein the processor (100) instructs the display device (10) to display at least two of the plurality of digital images, each of the images having a display size, display time, or display position on the display device that is based on the metadata associated with each image.
